(19) United States
(12) Patent Application Publication
(10) Pub. No.: US 2025/0321663 A1
(43) Pub. Date: Oct. 16, 2025

(54) GENERATING AUTOMATIONS IN DIGITAL ENVIRONMENTS

(71) Applicant: Notion Labs, Inc., San Francisco, CA (US)

(72) Inventor: Nicholas Giancarlo Gervasi, Montreal (CA)

(21) Appl. No.: 18/637,000

(22) Filed: Apr. 16, 2024

(51) Int. Cl. G06F 3/0482; G06F 40/177

(52) U.S. Cl. CPC G06F 3/0482; G06F 40/177

(57) ABSTRACT

A computing system outputs for display, a user interface for generating an automation associated with an object in a digital environment. The user interface includes a trigger control element to define a trigger for the automation and an action control element to define an action to be performed in response to the trigger. The computing system populates, within the user interface, a set of selectable options for the trigger or a set of selectable options for the action, where the set of selectable options for the trigger or the set of selectable options for the action are populated based on a property of the object in the digital environment. An automation is stored that includes a selected trigger and a selected action from the populated sets of selectable options. The computing system executes the automation based on satisfaction of the selected trigger.

### BACKGROUND

Content platforms provide a useful way to organize and share data and to collaborate between users. However, utility of these platforms can be limited without automations that cause actions to be performed automatically.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram illustrating a hierarchical organization of pages in a workspace.

FIG. 3 is a block diagram illustrating an environment in which custom automations are generated.

FIG. 4 is a block diagram illustrating functional modules within a content platform, according to some implementations.

FIGS. 5A-5G are user interfaces illustrating an example process for defining an automation.

FIG. 6A-6B are user interfaces illustrating another example automation.

FIG. 7 is a flowchart illustrating a process for generating custom automations in a digital environment, according to some implementations.

FIG. 8 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides mechanisms to generate custom automations in a digital environment. In some aspects, the techniques described herein include outputting for display, a user interface for generating an automation associated with an object in a digital environment. The user interface can include a trigger control element to define a trigger for the automation and an action control element to define an action to be performed in response to the trigger. Within the user interface is populated a set of selectable options for the trigger or a set of selectable options for the action, wherein the set of selectable options for the trigger or the set of selectable options for the action are populated based on a property of the object in the digital environment. An automation is stored that includes a selected trigger and a selected action from the populated sets of selectable options. The automation is executed based on satisfaction of the selected trigger.

Some implementations of the techniques described herein include generating an automation associated with a table in a digital environment. A user interface for generating the automation is populated with either a set of selectable options for a trigger that include options related to an update to a value in one or more columns of the plurality of columns, or a set of selectable options for an action that include options related to modifying a value in one or more columns of the plurality of columns. User selections from the user interface are stored as an automation associated with the table, which can be executed based on satisfaction of the selected trigger.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology can relate to a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database-meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

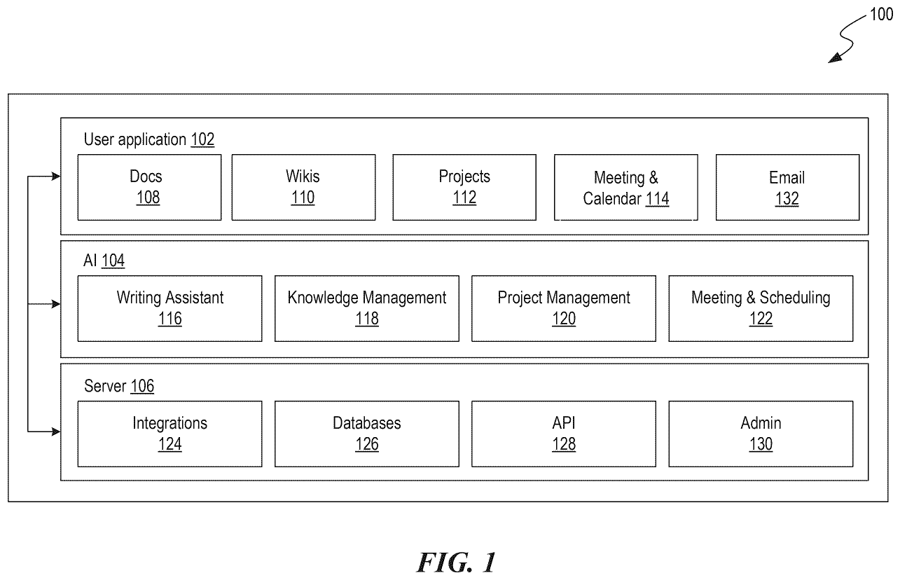

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The AI tool 104 is an integrated AI assistant that enables AI-based functions for the user application 102. In one example, the AI tool 104 is based on a neural network architecture. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Hierarchical Organizational Blocks in a Workspace

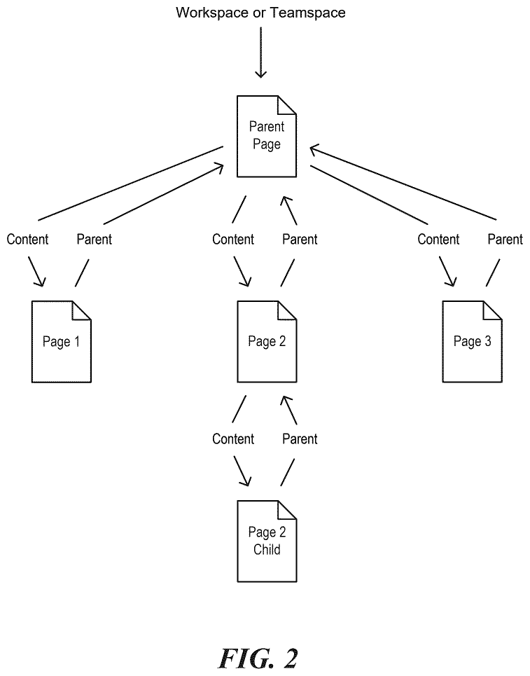

FIG. 2 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 2. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 2, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 2 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 2 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Automations in a Content Platform

A digital environment such as the data and project management platform 100 provides useful tools for users to store data, communicate, and collaborate. In such digital environments, automations can enhance the usability and power of these environments by automatically performing certain tasks in response to certain triggers. However, creating useful automations within a digital environment can be challenging. End users typically do not have access to lower-level functionality of the environment in order to deploy their own custom scripts. Users may also not have sufficient familiarity with or visibility into the environment to create automations that are useful and executable. To solve these problems, a content platform facilitates a process for users to create custom automations within the platform.

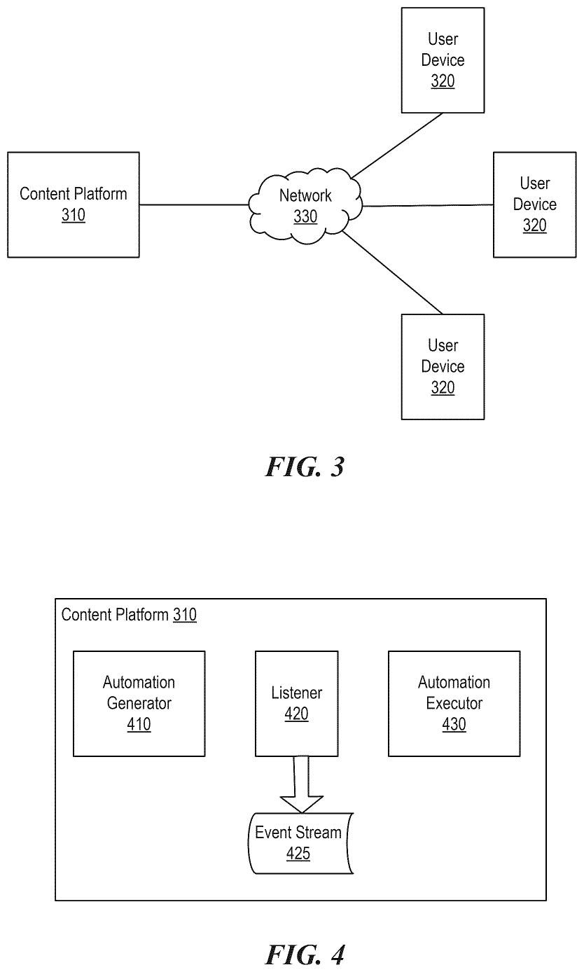

FIG. 3 is a block diagram illustrating an environment 300 in which custom automations are generated. As shown in FIG. 3, the environment 300 can include a content platform 310 and user devices 320 communicating over a network 330, such as the Internet.

The content platform 310 is a digital environment that is accessible over the network 330. In some implementations, the content platform 310 can include aspects of the data and project management platform 100. Content from the platform 310 can be accessed via the user devices 320, such as via a browser application or native application executing on the devices 320. The content platform 310 can maintain permissions that specify which users can view or modify various portions of the platform's content.

The content platform 310 includes a variety of types of objects. Objects can include, for example, a page, a text block, a table or database, a calendar, a timeline, an image, a button, an embedded document, or blocks in a block data model as described above. Some objects include other objects or are themselves sub-objects of other objects on the platform. For example, a page can include one or more text blocks, tables, images, etc. Objects can also be linked to other objects. For example, a first page may contain a link to a second page.

The user devices 320 are computing devices used by users to access the content platform 310. The user devices 320 can display user interfaces that render content from the platform, as well as user interfaces that facilitate creation and modification of automations on the platform. In response to inputs received at these user interfaces, the user devices 320 can communicate instructions to the content platform 310.

FIG. 4 is a block diagram illustrating functional modules within the content platform 310, according to some implementations. As illustrated in FIG. 4, the content platform 310 can include an automation generator 410, a listener 420, and an automation executor 430. Other implementations of the content platform 310 include additional, fewer, or different modules, or divide functionality differently between the modules.

The automation generator 410 facilitates a process for users to generate custom automations for the content platform 310. In general, an automation can include one or more triggers and one or more actions. The trigger is an event or property that defines a condition under which the automation is executed. Triggers can include, for example, an event occurring with respect to a specified object, such as the object being created, removed, or modified. Other types of triggers can include an event occurring before or after a specified time or date, an event occurring within a certain time before or after another specified event, an event not occurring within certain time before or after a specified time or before or after another specified event, an event being performed by a specified user, and so forth. Some triggers can be based on human mutation of data in the content platform 310 that satisfies a criterion specified within the trigger. For example, triggers can include an object property changing to “started” or “completed,” or an object being tagged with a tag identifying a certain team. Other triggers can be based on a computed property of an object. For example, a trigger can relate to a set of project tasks being overdue, where tasks are determined to be overdue by a process (e.g., running once per day) that identifies tasks that are not marked as “completed” and that have a due date in the past. Still other triggers can relate to events, manipulation of data, or computed properties that are performed autonomously in the content platform 310. Webhooks can be used to detect satisfaction of a trigger's criterion, or the operation of a webhook can itself be a trigger.

Actions are steps taken programmatically in response to a trigger. For example, an action can modify an object, create an object, or delete an object within the content platform 310. Actions can also perform other tasks within the content platform 310 that are not related to objects. For example, an action can include a webhook sending data from one part of the platform 310 to another. Some actions can include steps that are performed outside the content platform 310, such as sending a message to a user via an external messaging application (such as Slack, an email application, or a social media application), saving an object or a portion of an object to an external data repository, or uploading an object from an external data repository to the content platform 310. Actions can themselves be triggers for other automations, thus causing other actions to be performed in response to an action.

Automations can be associated with an object in the content platform 310. When associated with an object, at least one of the trigger or the action for the automation can be defined with respect to the object. For example, some automations are associated with an object because their trigger includes a change to a property of the object. Other automations are associated with an object because they include an action that is to be performed on the object.

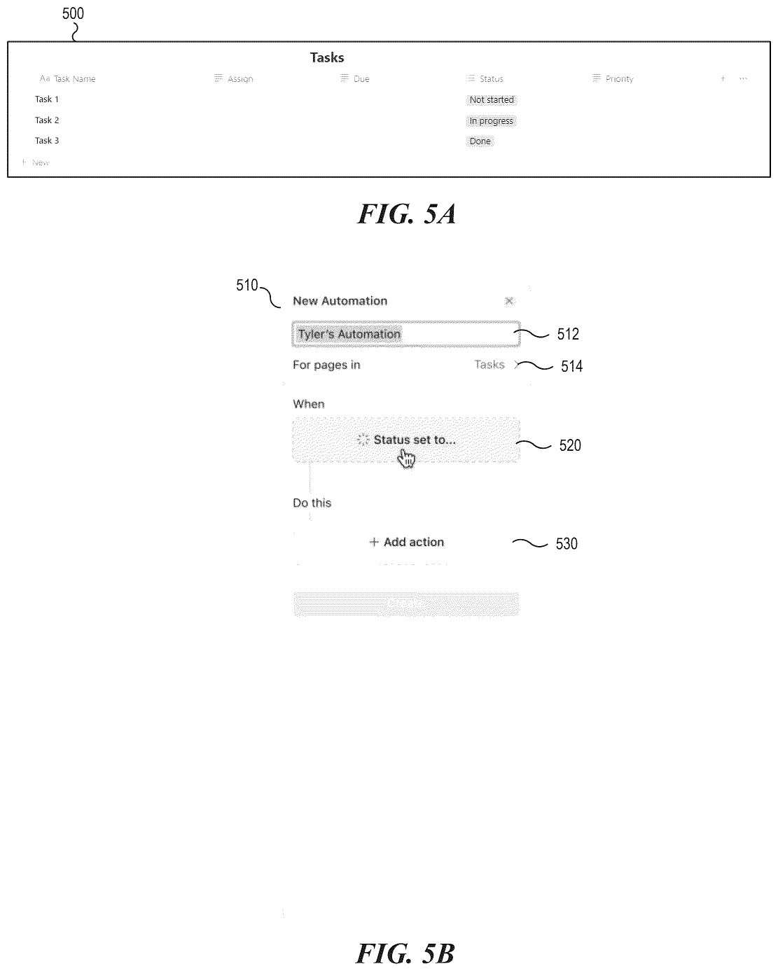

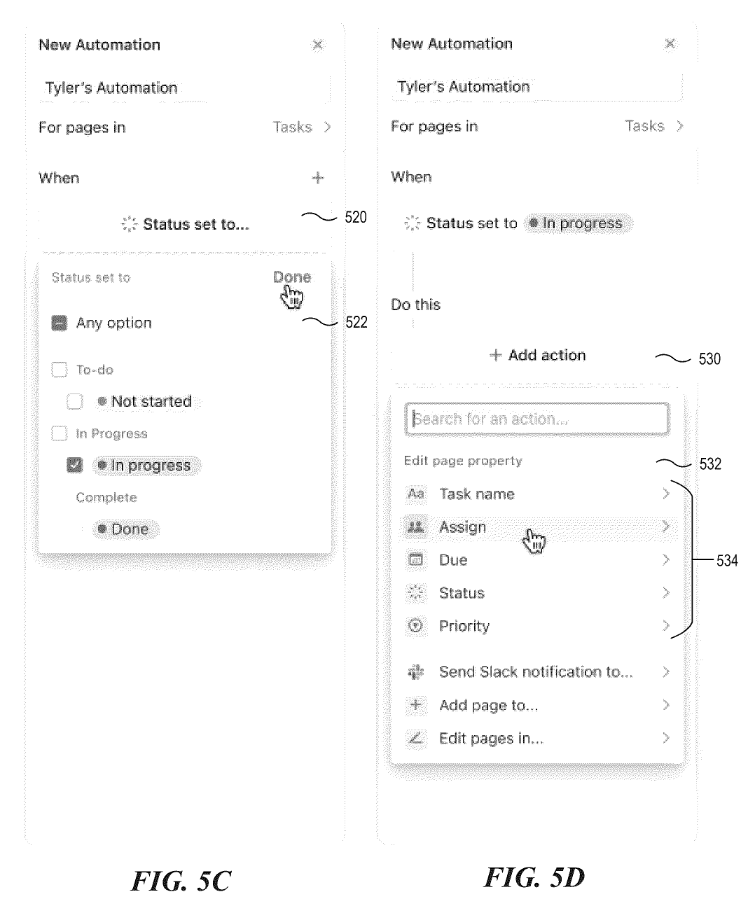

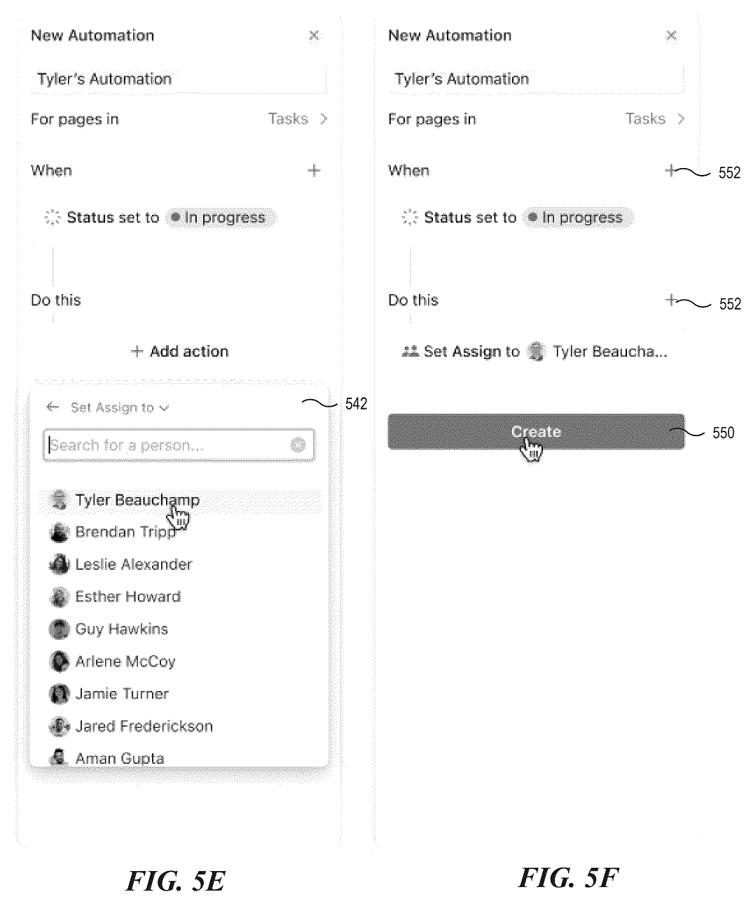

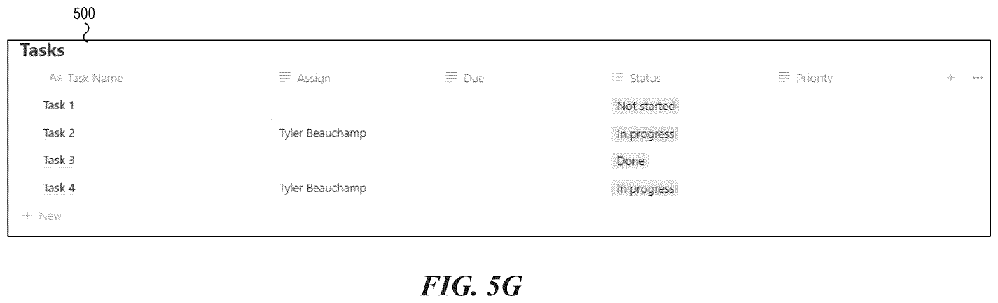

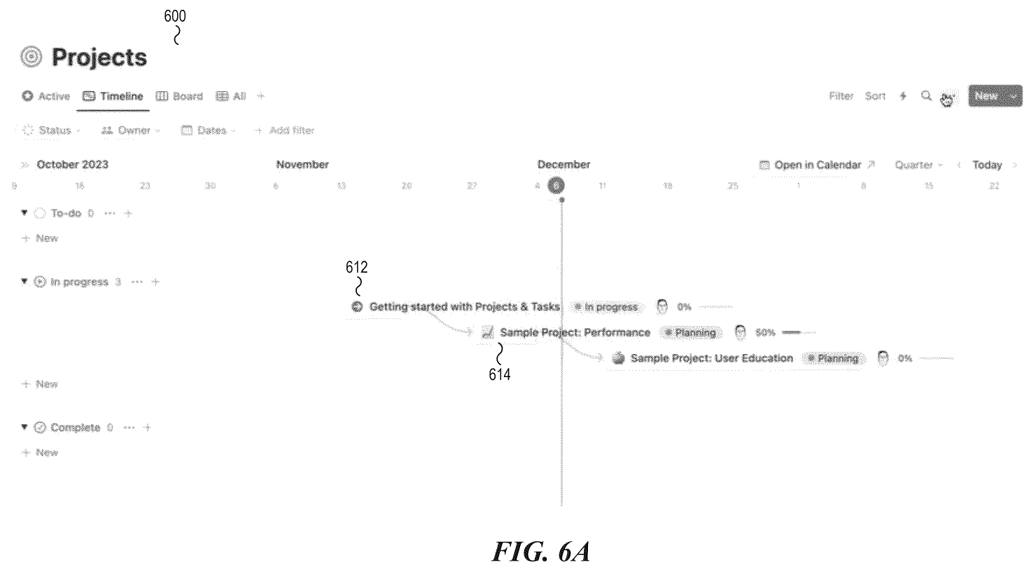

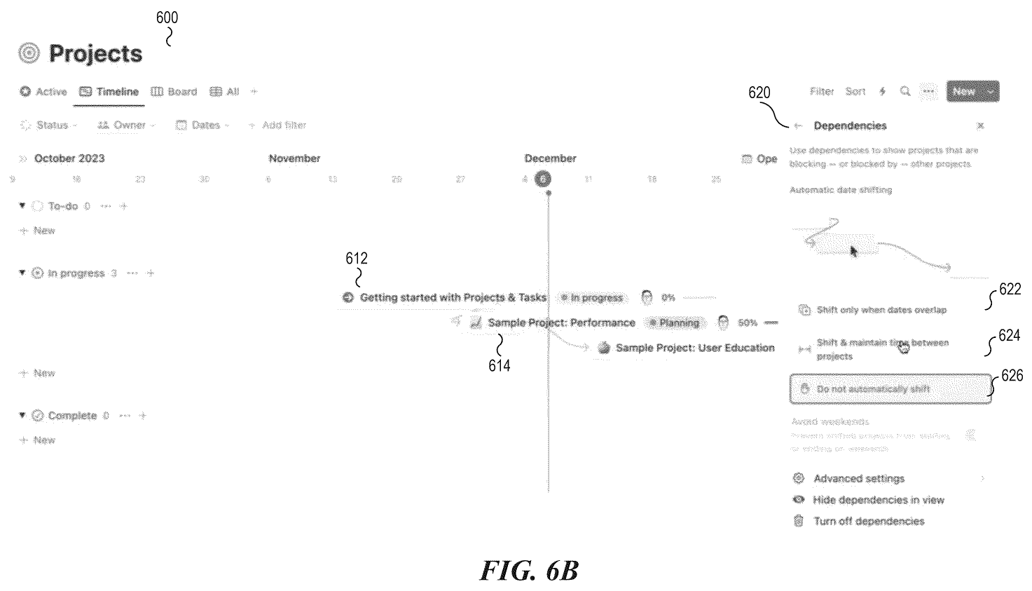

The automation generator 410 generates user interfaces for receiving user inputs to define aspects of the automation, including the object with which the automation will be associated, any triggers for the automation, and any actions to be performed when the trigger has been satisfied. The user interfaces generated by the automation generator 410 can be populated with options for the trigger and/or action based on properties of the object with which the automation is to be associated. By prepopulating the user interfaces with triggers or actions that are selected based on the object's properties, the automation generator 410 can improve the process for creating automations in the content platform 310. Example user interfaces generated by the automation generator 410 are illustrated below with respect to FIGS. 5 and 6.

The automation generator 410 receives user inputs for each automation's aspects and stores the completed automation, including any trigger(s) and action(s) specified by the user, in association with the corresponding object. When the trigger is satisfied, the corresponding action can be performed on the object.

The listener 420 is configured to listen to an event stream 425 of the content platform 310 to detect satisfaction of an automation's trigger. As events occur within the content platform 310, the events can be published to the event stream 425 to facilitate various operations within the platform, including executing automations. As a result, the event stream 425 is a stream of events on the content platform 310 that captures additions to the platform, subtractions from the platform, or modification of properties of objects on the platform. For example, the event stream 425 can identify events such as a page being added to or removed from the platform, an object being added or deleted, content within an object being added or deleted, a status change to an item within an object, a modification to a display property of an object (e.g., background color, text size, or border style), or a user being granted new permissions or having one or more permissions revoked. The listener 420 can be a programmatic component of the content platform 310 that is created in association with an automation or that is provided instructions based on an automation. The listener 420 observes the event stream 425 to detect specified events associated with specified objects. When an event satisfying a particular automation's trigger is detected, the listener 420 notifies the automation executor 430 associated with the corresponding automation.

The automation executor 430 executes the actions of custom automations when the corresponding triggers have been satisfied. The automation executor 430 can receive a notification from the listener 420 when the listener detects an event satisfying a trigger. Alternatively, some triggers can be detected by an application that renders pages of the content platform 310, such as a browser application or native application executing on a user device 320. For example, if a trigger is satisfied when a user changes a property of an object displayed by the application, the application can detect the change to the object's property and send a notification to the automation executor 430 to indicate that the trigger has been satisfied.

To execute an action, the automation executor 430 can include a process that is able to modify objects in the content platform 310, create objects, delete objects, or perform other tasks within the content platform 310 as specified by the action. For example, the automation executor 430 can change a feature within a table, write data to a table or delete data from a table, generate or delete a text block, modify a display property of an object or portion of an object, and so forth.

### Example User Interfaces

An example process for defining an automation is illustrated in FIGS. 5A-5G. The example automation is defined with respect to a table 500 entitled “Tasks,” illustrated in FIG. 5A, as an example object associated with the automation. User interfaces generated by the automation generator 410 to generate the example automation for the “Tasks” table 500 are illustrated in FIGS. 5B-5F.

FIG. 5B illustrates an example interface 510 for defining an automation associated with an object in the content platform 310. The interface 510 includes a text entry box 512 to name the automation. The interface 510 further indicates that it is an automation associated with the “Tasks” table 500 illustrated in FIG. 5A, but provides an option 514 to select an object with which the automation will be associated

As also illustrated in FIG. 5B, the interface 510 also includes a region 520 to define a trigger for the automation and a region 530 to define an action to be performed in response to the trigger. A user can interact with each of the regions 520, 530 to select corresponding triggers and actions.

FIG. 5C illustrates an example menu 522 that is displayed when a user interacts with the trigger definition region 520. Within the menu 522 is a set of selectable options for the trigger that is populated based on properties of the object with which the automation is to be associated. For example, the menu 522 illustrates the three status labels “Not started,” “In progress,” and “Done.” These status labels can be labels that are retrieved from the “Tasks” table 500 shown in FIG. 5A as the set of labels that are assigned to particular tasks within the table. If a user adds an additional label to the table (e.g., “On hold”), the new label can be added to the menu 522 the next time a user interacts with the trigger definition region 520. By populating the trigger options menu 522 with the available status labels in the table, the automation generator 410 can increase the likelihood that the trigger will be detectable (e.g., by increasing the likelihood that the user will define the trigger based on a status that is likely to exist in the selected column of the table, rather than defining the trigger based on a status label that is not present in the table, a misspelling of the intended status label, or a label that exists only in a different column of the table). The trigger options menu 522 also reduces user confusion when defining the trigger for an automation and enables the user to easily define the trigger with few clicks.

FIG. 5D illustrates an example menu 532 that is displayed when a user interacts with the action definition region 530. Within the menu 532 is a set of selectable options for the action. Like the menu 522 of selectable trigger options, the action options menu 532 can be populated at least in part based on properties of the object with which the automation is to be associated. For example, FIG. 5A illustrates that the “Tasks” table 500 includes columns for task name, assignee, due date, status, and priority. As illustrated in FIG. 5D, the menu 532 includes options 534 to modify each of these columns as part of the automation action. The menu 532 can further list other action options that are available to the user, such as sending a message to another user, creating a new object outside the table, or editing another object in the digital environment. By populating the menu 532 with action options based on the properties of the object, the automation generator 410 can increase the likelihood that the action will be performable on the object and enable the action to be defined within a small number of clicks.

FIG. 5E illustrates an example menu 542 that displayed when a user selects the option to modify the “assign” column of the “Tasks” table 500 from the menu 532 shown in FIG. 5D in order to cause tasks to be assigned to a particular team member. Like other menus, the menu 542 can be populated based on properties of the object with which the automation is to be associated. In the example of FIG. 5E, a set of users and potential assignees for a task are listed in the menu. The set of users can be selected, for example, from the users who have permission to view or edit the object with which the automation is associated or a portion of the content platform 310 in which the object is located, users who have previously interacted with the object or portion of the content platform, or users who are already listed in the “Tasks” table as being assigned to other tasks.

Once the user has specified at least one trigger and at least one action, FIG. 5F illustrates that the user can select a “Create” button 550 to complete the process for creating a new automation. The user can instead select one of the plus buttons 552 to add another trigger or action to the automation before finalizing the automation. Once the automation has been created, the automation generator 410 can provide similar user interfaces to those illustrated in FIGS. 5B-5F to enable a user to edit the automation as desired.

FIG. 5G illustrates an example of the table 500 after the automation has been created. In FIG. 5G, a new task, Task 4, has been added to the table 500. When the status of Task 4 is updated to “In progress,” the automation associated with the table causes the task to be assigned to the team member specified in the automation. As illustrated in FIG. 5G, the automation can be associated with the table 500 as a whole, rather than a particular row or cell within the table, such that a single automation causes an update to the “assignee” column when a label in the “status” column is “In progress.”

FIGS. 6A-6B illustrate another example automation that can be performed in a digital environment. FIG. 6A illustrates a timeline 600 that displays multiple tasks and an intended duration of time for each task. For example, a first task 612 is scheduled for a first duration of time and a second task 614 is scheduled for a second duration of time after the first duration. A user can interact with the timeline 600 to change the first or second durations, such as by increasing or decreasing the size of each task indicator displayed on the timeline to increase or decrease the length of each duration, moving the task indicator to start the task's duration on a different day, or moving a task indicator to change an amount of time between the end of the first duration and the beginning of the second duration.

The timeline 600 can be linked to an external data source from which the timeline is generated, such as a table that lists tasks and their properties. The table can be similar to the “Tasks” table 500 in FIG. 5A, for example. In some implementations, rather than interacting with the timeline 600 to modify task durations, a user can modify task durations within the source table. The content platform 310 can further cause automatic modifications to the task durations in the source table.

Tasks in the timeline 600 can be dependent on other tasks. For example, if the first task 612 must be completed before the second task 614 can begin, the source table can include control data to indicate that the second task 614 is blocked by the first task 612. The control data can specify that one task is entirely blocked by another (e.g., no portion of the second task can begin until the first task is entirely complete), one task is partially blocked by another (e.g., the second task can begin before the first task is complete, but the second task cannot be completed until the first task is complete), one task is blocked with a lag time between the task and another task (e.g., no portion of the second task can begin until a certain amount of time has elapsed after completion of the first task), or one task is dependent on another in a different manner.

When at least some of the tasks in the timeline 600 are dependent on another task, an automation can be defined to automatically modify tasks in the timeline 600 based on modifications to other tasks. FIG. 6B illustrates an example user interface 620, which can be generated by the automation generator 410 in at least some implementations. The user interface 620 enables a user to specify rules for automatic date shifting of tasks based on dependencies between tasks. In the illustrated example, a user can select an option 622 to shift the duration of one task only when durations overlap, an option 624 to shift a task's duration while maintaining a specified amount of time between tasks, or an option 626 to not automatically shift any of the durations on the timeline 600.

The user's selection from the interface 620 can be stored as an automation associated with the timeline 600 and/or the source table for the timeline, where a trigger for the automation is the modification of a duration for a task. When a task's duration is changed, the content platform 310 detects the change and performs a corresponding action to modify the timeline 600. For example, if a second task is dependent on a first task, the content platform 310 can automatically shift the duration for the second task on the timeline 600 when the duration for the first task is shifted in order to preserve a dependency between the first and second tasks. The content platform 310 can modify both the duration indicated in the source table for the timeline as well as the display of the timeline itself to reflect the modification to the second duration.

### Generating Custom Automations in a Digital Environment

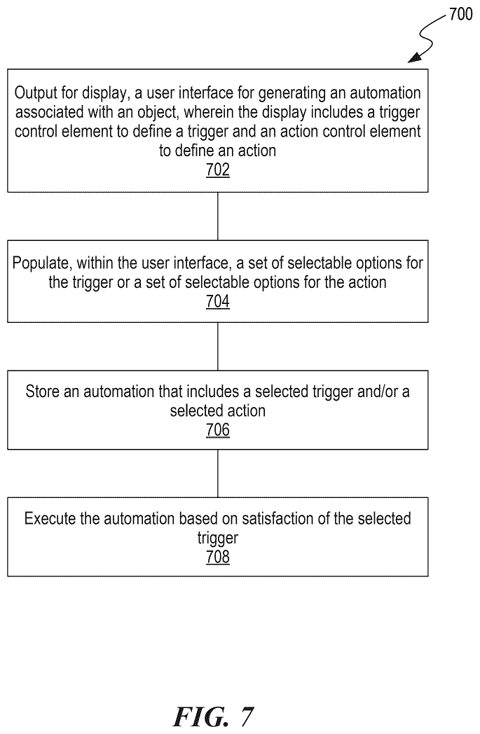

FIG. 7 is a flowchart illustrating a process 700 for generating custom automations in a digital environment, according to some implementations. By way of example, the process 700 is described as being performed by a computing system associated with the content platform 310. However, the process 700 can be performed by any computing system and used to generate automations in any of a variety of types of digital environments. Other implementations of the process 700 can include additional, fewer, or different steps, or can perform the steps in different orders.

At 702, the computing system outputs for display a user interface for generating an automation associated with an object in a digital environment. The user interface includes a trigger control element and an action control element. The trigger control element is interactive to define a trigger for the automation, while the action control element is interactive to define an action to be performed in response to the trigger. In an example, the object is a table that includes a plurality of columns.

At 704, the computing system populates, within the user interface, a set of selectable options for the trigger or a set of selectable options for the action. The set of selectable options for the trigger or the set of selectable options for the action are populated based on a property of the object in the digital environment. For example, the options for the trigger can include features of the object that are mutable as users of the content platform 310 interact with the object or related objects, giving the user the option to create a trigger that is satisfied when a change to a certain feature of the object is detected. Similarly, options for the action can include features of the object that are able to be automatically modified by the computing system. When the object is a table, for example, the set of selectable options for the trigger can include options that relate to an update to a value in one or more columns of the plurality of columns. The set of selectable options for the action can include options that relate to modifying a value in one or more columns of the plurality of columns

At step 706, after a user selection of a trigger and/or an action from the populated sets of selectable options, the computing system stores an automation that includes the selected trigger and action. The computing system can execute the automation, at 706, based on satisfaction of the selected trigger. One or both of the trigger and action can relate to the object with which the automation is associated. For example, when generating an automation for a table, the selected trigger can relate to an update to a value in a first column of the table and/or the selected action can relate to modifying a value in a second column of the table. A trigger or action can also relate to another object in the digital environment. For example, an automation can have a trigger that is satisfied by a value in a table but that causes an action outside of the table. Alternatively, an automation can have a trigger from a source outside the table, but cause an action that modifies a value within a table.

At step 708, the computing system executes the automation based on satisfaction of the selected trigger. For example, the computing system deploys a listener that observes events on an event stream to detect an event that satisfies an automation's trigger. Alternatively, the computing system receives a notification from an application rendering a portion of the content platform 310, indicating that an action within the application has satisfied a trigger.

### Computer System

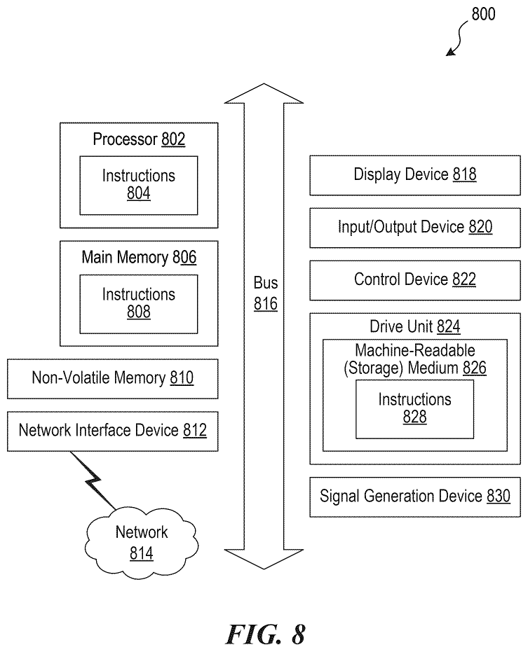

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a display device 818, an input/output device 820, a control device 822 (e.g., keyboard and pointing device), a drive unit 824 that includes a machine readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 800. In some implementations, the computer system 800 can be an embedded computer system, a system-on-chip (SOC), a single-board computer (SBC) system, or a distributed system such as a mesh of computer systems or include one or more cloud components in one or more networks. Where appropriate, one or more computer systems 800 can perform operations in real time, near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A non-transitory, computer-readable storage medium comprising instructions recorded thereon, wherein the instructions, when executed by at least one data processor of a system, cause the system to:
output for display, a user interface for generating an automation associated with a table in a digital environment,
wherein the user interface includes:
a trigger control element to define a trigger for the automation, and
an action control element to define an action to be performed in response to the trigger; and
wherein the table includes a plurality of columns;
populate, within the user interface, a set of selectable options for the trigger or a set of selectable options for the action,
wherein the set of selectable options for the trigger include options that relate to an update to a value in one or more columns of the plurality of columns; and
wherein the set of selectable options for the action include options that relate to modifying a value in one or more columns of the plurality of columns;
store an automation that includes a selected trigger and a selected action from the populated sets of selectable options; and
execute the automation based on satisfaction of the selected trigger.

2. The non-transitory computer-readable storage medium of claim 1, wherein the selected trigger is related to an update to a value in a first column of the plurality of columns of the table, and wherein executing the automation based on satisfaction of the selected trigger comprises:
performing the selected action upon detecting the the value in the first column of the table satisfies the selected trigger.

3. The non-transitory computer-readable storage medium of claim 2, wherein the selected action is an action to be performed on an object in the digital environment other than the table.

4. The non-transitory computer-readable storage medium of claim 1:
wherein the selected trigger is associated with an object in the digital environment other than the table;
wherein the selected action comprises modifying a value in a second column of the plurality of columns of the table; and
wherein executing the automation based on satisfaction of the selected trigger comprises modifying the value in the second column.

5. The non-transitory computer-readable storage medium of claim 1:
wherein the selected trigger includes an update to a value in a first column of the plurality of columns of the table;
wherein the selected action comprises modifying a value in a second column of the plurality of columns of the table; and
wherein executing the automation based on satisfaction of the selected trigger comprises:
detecting, in a first row of the plurality of rows, the update to the value in the first column; and
modifying the value in the second column of the first row in response to the detection.

6. The non-transitory computer-readable storage medium of claim 1:
wherein the table stores data associated with a plurality of tasks and a first column of the plurality of columns specifies a corresponding duration for each task, including:
a first task having a first duration, and
a second task having a second duration, at least part of the second duration being after an end of the first duration;
wherein the table is linked to a timeline that displays a visual representation of the plurality of tasks, including a first indicator of the first duration and a second indicator of the second duration;
wherein the selected trigger includes a modification to the first duration; and
wherein executing the automation based on satisfaction of the selected trigger comprises:
modifying the second duration in the table based on the modification to the first duration to preserve a dependency between the first duration and the second duration; and
updating a display of the timeline to indicate the modified second duration.

7. The non-transitory computer-readable storage medium of claim 1, wherein executing the automation based on satisfaction of the selected trigger comprises:
deploying a listener on an event stream in the digital environment, the listener configured to detect an event that satisfies the selected trigger; and
executing the selected action in response to the detection of the event by the listener.

8. The non-transitory computer-readable storage medium of claim 1, wherein the table is displayed in a page of the digital environment rendered by an application at a client device, and wherein executing the automation based on satisfaction of the selected trigger comprises:
receiving, from the application, a notification indicating that an action within the application satisfied the selected trigger; and
executing the selected action in response to the notification.

9. A system comprising:
at least one hardware processor; and
at least one non-transitory memory storing instructions, which, when executed by the at least one hardware processor, cause the system to:
output for display, a user interface for generating an automation associated with a table in a digital environment,
wherein the user interface includes:
a trigger control element to define a trigger for the automation, and
an action control element to define an action to be performed in response to the trigger; and
wherein the table includes a plurality of columns;
populate, within the user interface, a set of selectable options for the trigger or a set of selectable options for the action,
wherein the set of selectable options for the trigger include options that relate to an update to a value in one or more columns of the plurality of columns; and
wherein the set of selectable options for the action include options that relate to modifying a value in one or more columns of the plurality of columns;
store an automation that includes a selected trigger and a selected action from the populated sets of selectable options; and
execute the automation based on satisfaction of the selected trigger.

10. The system of claim 9, wherein the selected trigger is related to an update to a value in a first column of the plurality of columns of the table, and wherein executing the automation based on satisfaction of the selected trigger comprises:
performing the selected action upon detecting the the value in the first column of the table satisfies the selected trigger.

11. The system of claim 10, wherein the selected action is an action to be performed on an object in the digital environment other than the table.

12. The system of claim 9:
wherein the selected trigger is associated with an object in the digital environment other than the table;
wherein the selected action comprises modifying a value in a second column of the plurality of columns of the table; and
wherein executing the automation based on satisfaction of the selected trigger comprises modifying the value in the second column.

13. The system of claim 9:
wherein the selected trigger includes an update to a value in a first column of the plurality of columns of the table;
wherein the selected action comprises modifying a value in a second column of the plurality of columns of the table; and
wherein executing the automation based on satisfaction of the selected trigger comprises:
detecting, in a first row of the plurality of rows, the update to the value in the first column; and
modifying the value in the second column of the first row in response to the detection.

14. The system of claim 9:
wherein the table stores data associated with a plurality of tasks and a first column of the plurality of columns specifies a corresponding duration for each task, including:
a first task having a first duration, and
a second task having a second duration, at least part of the second duration being after an end of the first duration;
wherein the table is linked to a timeline that displays a visual representation of the plurality of tasks, including a first indicator of the first duration and a second indicator of the second duration;
wherein the selected trigger includes a modification to the first duration; and
wherein executing the automation based on satisfaction of the selected trigger comprises:
modifying the second duration in the table based on the modification to the first duration to preserve a dependency between the first duration and the second duration; and
updating a display of the timeline to indicate the modified second duration.

15. A method comprising:
outputting for display, a user interface for generating an automation associated with an object in a digital environment, wherein the user interface includes:
a trigger control element to define a trigger for the automation, and
an action control element to define an action to be performed in response to the trigger;
populating, within the user interface, a set of selectable options for the trigger or a set of selectable options for the action, wherein the set of selectable options for the trigger or the set of selectable options for the action are populated based on a property of the object in the digital environment;
storing an automation that includes a selected trigger and a selected action from the populated sets of selectable options; and
executing the automation based on satisfaction of the selected trigger.

16. The method of claim 15, wherein the selected trigger is associated with a feature of the object, and wherein executing the automation based on satisfaction of the selected trigger comprises:
performing the selected action upon detecting the feature of the object satisfies the selected trigger.

17. The method of claim 16, wherein the set of selectable options for the trigger include a set of mutable features of the object, and wherein the feature of the object is a mutable feature selected from the set of mutable features.

18. The method of claim 15, wherein the selected action is an action for performance on the object upon satisfaction of the selected trigger.

19. The method of claim 15:
wherein the object in the digital environment is a table including a plurality of rows and a plurality of columns;
wherein the selected trigger includes an update to a value in a first column of the plurality of columns;
wherein the selected action comprises modifying a value in a second column of the plurality of columns; and
wherein executing the automation based on satisfaction of the selected trigger comprises:
detecting, in a first row of the plurality of rows, the update to the value in the first column; and
modifying the value in the second column of the first row in response to the detection.

20. The method of claim 15:
wherein the object in the digital environment is a timeline that displays a plurality of tasks, including:
a first task having a first duration along the timeline, and
a second task having a second duration along the timeline, at least part of the second duration being after an end of the first duration;
wherein the selected trigger includes a modification to the first duration; and
wherein executing the automation based on satisfaction of the selected trigger comprises:
modifying the second duration based on the modification to the first duration to preserve a dependency between the first duration and the second duration; and
updating a display of the timeline to indicate the modified second duration.
